(19) United States
(12) Patent Application Publication
(10) Pub. No.: US 2003/0212911 A1
(43) Pub. Date: Nov. 13, 2003

(54) Secure control of access to data stored on a storage device of a computer system

(75) Inventors: David Carroll Challener, Raleigh, NC (US); James Patrick Hoff, Raleigh, NC (US); Kevin Snow Mccurley, San Jose, CA (US); John Hancock Nicholson III, Durham, NC (US); David Rivera, Durham, NC (US); James Peter Ward, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/144,200

(22) Filed: May 13, 2002

(51) Int. Cl. H04L 9/32

(52) U.S. Cl. 713/202; 713/181; 713/1

(57) ABSTRACT

Enhanced security in controlling access to data files stored in a read/write storage device is achieved in that the storage device may be specifically linked to a specific computer system, and linked in such a way that access will be granted only when a series of exchanges exemplary of that linkage occurs. Access to data stored in a read/write storage device is to be granted only when the device is associated with a specific computer system and further only when appropriate password entry is verified by the storage device.

### RELATED PATENTS

The interested reader is referred, for assistance in understanding the inventions here described, to U.S. Pat. Nos. 5,388,156, issued Feb. 7, 1995, and 6,229,712, issued May 8, 2001, both held in common with the inventions here described. The referenced patents are relevant to the description which follows and are hereby incorporated by reference into this description as fully as if here repeated in full. Specific references to portions of the prior patents to which attention is directed follow in an effort toward brevity of the description here given.

### BACKGROUND OF THE INVENTION

Personal computer systems as described and shown, for example, in U.S. Pat. No. 5,388,156 beginning in Column 6 at line 33 and continuing through Column 8 at line 19 and related FIGS. 1 through 3 have been known and in use for some time. Configurations for such systems can vary from those shown in the '156 patent disclosure here incorporated by reference, as is known to persons of skill in the applicable arts and illustrated by other patent disclosures including the '712 patent disclosure beginning in Column 2 at line 24 and related FIGS. 1 through 3. The patents here referenced have been selected merely as being exemplary and due to ownership in common with the inventions here disclosed.

As evidenced by the referenced prior '156 patent, there have been concerns over the security of information stored in such computer systems, and steps have been taken to enable protection of such information. Conventionally, such protection is left to the selection and implementation of a system owner or a designated administrator for the system owner. In some instances, choices are made that information protection will not be enabled. In other instances, choices are made that information protection will be maximized.

In the latter instance, where protection of information is to be maximized, recognition can be given to the fact that a read/write storage device may be exchanged from one computer system to another computer system. Where the read/write storage device is the somewhat traditional rotating disk, magnetic media device known as a hard drive or hard file, that exchange may be more or less difficult, depending upon the manner in which the system is housed. With a conventional system of the type known as a desktop workstation, exchange of a storage device may require significant dismantling of the system. With certain notebook systems, the exchange is relatively quick and easy. With devices which are intentionally detachable, such as a device coupled through a Universal Serial Bus (USB) port, the exchange is trivial. Indeed, with the last mentioned class of storage devices, the very triviality of exchange is touted as an advantage, enabling ready mobility of data files. The last mentioned class of devices, as currently available, include flash and DRAM memory arrays, as well as rotating disc magnetic and optical media. The present invention is contemplated as applicable to all such devices.

One existing approach to the security problems presented by such portability is the provision of a password specifically associated with the storage device. As an example only, a hard disk supplied with a notebook system usually has the capability of setting what may be known as a hard drive password. Thus there may be password protection for access to the boot capability, and separate password protection for access to the storage device. If a storage device password is correctly passed to the storage device or hacked, then full access to the contents of the device is enabled. For certain purposes, the level of security thus attained may still be below what may be optimal.

### SUMMARY OF THE INVENTION

The present invention deems it desirable to provide enhanced security controlling access to data files stored in a read/write storage device of the types described above. In pursuing this goal, the present invention contemplates that a storage device may be specifically linked to a specific computer system, and linked in such a way that access will be granted only when a series of exchanges exemplary of that linkage occurs.

Stated differently, the present invention contemplates that access to data stored in a read/write storage device is to be granted only when the device is associated with a specific computer system and further only when appropriate password entry is verified by the storage device.

### BRIEF DESCRIPTION OF THE DRAWINGS

Some of the purposes of the invention having been stated, others will appear as the description proceeds, when taken in connection with the accompanying drawings, in which:

FIG. 1 is a representation of a sequence of steps followed on initial linking of a storage device to a computer system;

FIG. 2 is a representation of a sequence of steps followed when a computer system having a storage device linked through an operation such as that of FIG. 1 is subsequently brought into operation; and

FIG. 3 is a representation of a computer readable medium carrying instructions effective to cause the sequences of FIGS. 1 and 2.

### DESCRIPTION OF THE PREFERRED EMBODIMENT(S)

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

Briefly stated, the present invention encompasses a method of operating a computer system during installation of a storage device to be protected, a method of operating the system during subsequent access to the storage device, a computer system configured for such access control, and the provision of program instructions enabling controls as here described.

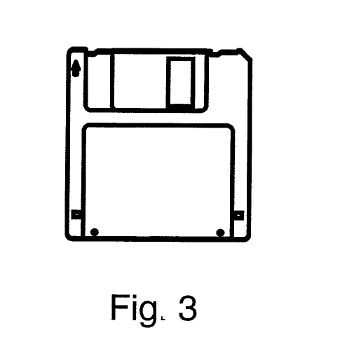

Specific illustrations of a computer systems and the elements of the system are here omitted, reliance being placed on the incorporations by reference set forth above. For purposes of the present discussion, it is contemplated by the present invention that the computer system implementing this invention have an accessible read/write storage device. Most usually, this device will be a magnetic media, rotating disk device of the type known as a hard drive and will be included within a common housing with other components of the system. However, it is known that the storage device may be optically based, or be based on a type of memory known as flash memory, and may be accessed through a USB or network connection rather than being directly housed within a common enclosure with the other components of the system. One example is illustrated at 19 in FIG. 3 of the '712 referenced patent.

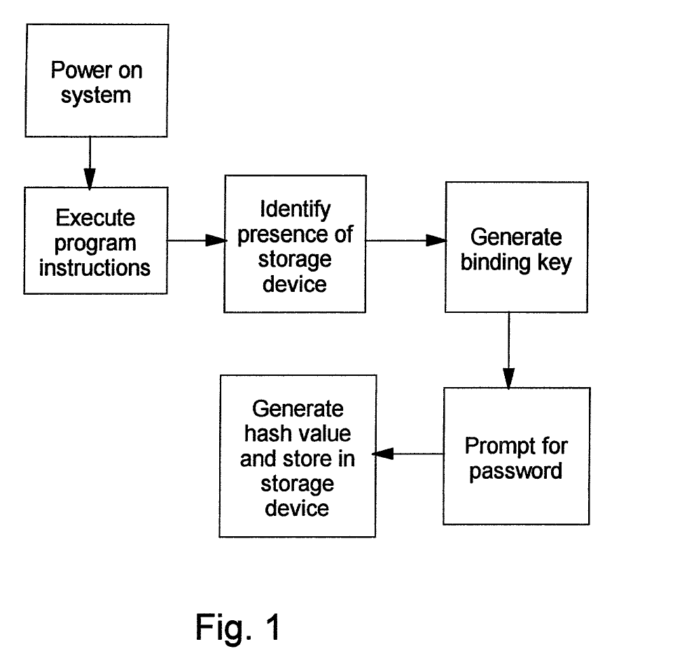

The present invention contemplates that a read/write storage device may be identified or bound to a specific computer system by the creation of what is here called a binding key on initial installation of the storage device. In so binding the system and device, a sequence is followed in which program instructions effective on powering on of the system to initiate system operation, typically known and referenced as BIOS code (see the discussion in the '156 patent) identify the presence of the read/write storage device and generate a code sequence functioning as the binding key linking the read/write storage device specifically to the computer system. During this initial installation, the BIOS prompts a user of the system to enter a password for controlling access to the read/write storage device. The system then generates a hash value from the binding key and password and stores the hash value in a protected area of the read/write storage device for subsequent retrieval in exercising control of system access to the read/write storage device. These steps are illustrated in FIG. 1.

The generation of a hash value is a known technique in which an otherwise meaningless value is created by applying a known algorithm to a data string or set. One usual purpose of hashing, exercised here, is to reduce the length or size of a data record, in order that less storage space be required or less time be expended in transferring the value.

The storage of the hash value in the storage device enables a particular sequence when the device is later to be accessed as for use. When the system is powered on in anticipation of a work session, the BIOS code executes to initiate system operation. In response to powering on, a nonce string is generated in the read/write storage device. As here used, the word “nonce” indicates a one time, non-recurring, event. That is, “nonce” is used in the dictionary sense of the present or immediate occasion or purpose. This generation of a nonce string is a significant feature of the security obtained, as will be pointed out hereinafter. On each subsequent powering on of the system, the string generated as the nonce string differs from whatever may have been previously, or will next subsequently be, generated.

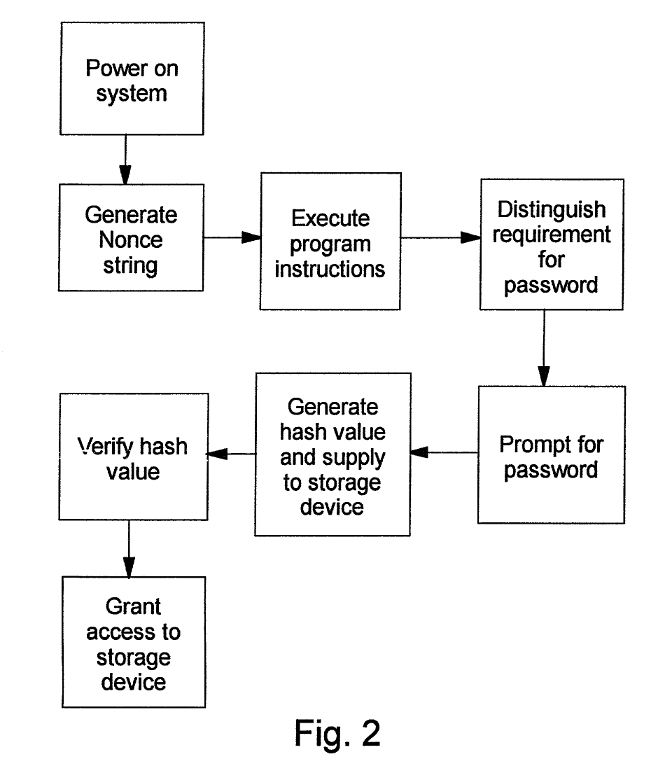

The BIOS code distinguishes between a requirement for entry of at least one password to access the read/write storage device and no requirement for entry of a password, which is a normal BIOS function. In response, an operator is prompted to enter a password by determination that entry of a password is required to access the read/write storage device. When the password is supplied, the code generates a hash value from the nonce string, the password and the system binding key for the read/write storage device. That hash value is then supplied to the read/write storage device where it is checked for verification that the hash value is derived from the nonce string, the password and the system binding key. If this is verified correct, then read/write access to the read/write storage device is granted. These steps are illustrated in FIG. 2.

Inclusion of the nonce string in these sequences protects against capture of the hash value in an effort to hack the security of the storage device. Further, inclusion of the binding key protects against the possibility of hacking access to the storage device from a system other than the one to which is it specifically bound. Use of hash values minimizes the storage space required to make the invention operative.

In use, an apparatus which implements these procedures will have a computer system, a read/write storage device accessible to the system in the manners described above, and a system binding key stored accessibly to said system and said storage device and identifying said system and said storage device as being specifically linked. Additionally, the apparatus will have program instructions such as BIOS code stored accessibly to said system and said storage device and operative when executing on said system and said storage device to generate a nonce string as here defined in the read/write storage device in response to powering on of the system and prompt an operator of the system to enter a password associated with access to the storage device. The system will, in executing the instructions, generate a hash value from the nonce string, the password and the system binding key and supply the hash value to the read/write storage device. The storage device will act to verify that the hash value is derived from the nonce string, the password and the system binding key and grant read/write access to the read/write storage device on verification of the hash value. Such an apparatus may be as illustrated in FIGS. 1 through 3 of each of the '156 and '712 patents referenced above.

FIG. 3 illustrates a computer readable medium in the form of a diskette 10 bearing program instructions readable by a system such as those of FIGS. 1 through 3 of the referenced patents and effective on execution by such a system to perform the steps of FIGS. 1 and 2 of this description.

In the drawings and specifications there has been set forth a preferred embodiment of the invention and, although specific terms are used, the description thus given uses terminology in a generic and descriptive sense only and not for purposes of limitation.

What is claimed is:

1. A method comprising the steps of:
executing, in a computer system having an accessible read/write storage device, program instructions effective on powering on of the system to initiate system operation;
identifying the presence of the read/write storage device and generating a binding key linking the read/write storage device specifically to the computer system;
prompting a designated user to enter a password for controlling access to the read/write storage device; and
generating a hash value from the binding key and password and storing the hash value in a protected area of the read/write storage device for subsequent retrieval in exercising control of system access to the read/write storage device.

2. A method according to claim 1 executed in a computer system having a hard disk drive as the storage device.

3. A method comprising the steps of:
executing, in a computer system having an accessible read/write storage device, program instructions effective on powering on of the system to initiate system operation;
generating in response to powering on of the system a nonce string in the read/write storage device;
distinguishing by execution of the program instructions between a requirement for entry of at least one password to access the read/write storage device and no requirement for entry of a password;
prompting an operator of the system to enter a password by the execution of the program instructions in response to a determination that entry of a password is required to access the read/write storage device;
generating a hash value from the nonce string, the password and a system binding key for the read/write storage device;
supplying the hash value to the read/write storage device;
verifying in the read/write storage device that the hash value is derived from the nonce string, the password and the system binding key; and
granting read/write access to the read/write storage device on verification of the hash value.

4. A method according to claim 3 executed in a computer system having a hard disk drive as the storage device.

5. A method comprising the steps of:
on installation of a read/write storage device in a computer system,
executing, in the computer system receiving the read/write storage device, program instructions effective on powering on of the system to initiate system operation;
identifying the presence of the read/write storage device and generating a binding key linking the read/write storage device specifically to the computer system;
prompting a designated user to enter a password for controlling access to the read/write storage device; and
generating a hash value from the binding key and password and storing the hash value in a protected area of the read/write storage device for subsequent retrieval in exercising control of system access to the read/write storage device; then
on subsequent powering on of the computer system;
executing, in the computer system having the read/write storage device, program instructions effective on powering on of the system to initiate system operation;
generating in response to powering on of the system a nonce string in the read/write storage device;
prompting an operator of the system to enter a password by the execution of the program instructions;
generating a hash value from the nonce string, the password and the system binding key for the read/write storage device;
supplying the hash value to the read/write storage device;
verifying in the read/write storage device that the hash value is derived from the nonce string, the password and the system binding key; and
granting read/write access to the read/write storage device on verification of the hash value.

6. A method according to claim 5 executed in a computer system having a hard disk drive as the storage device.

7. Apparatus comprising:
a computer system;
a read/write storage device accessible to the system;
a system binding key stored accessibly to said system and said storage device and identifying said system and said storage device as being specifically linked; and
program instructions stored accessibly to said system and said storage device and operative when executing on said system and said storage device to:
generate in response to powering on of the system a nonce string in the read/write storage device;
prompt an operator of the system to enter a password by the execution of the program instructions;
generate a hash value from the nonce string, the password and said system binding key;
supply the hash value to the read/write storage device;
verify in the read/write storage device that the hash value is derived from the nonce string, the password and the system binding key; and
grant read/write access to the read/write storage device on verification of the hash value.

8. Apparatus according to claim 7 wherein said storage device is a hard disk drive.

9. Apparatus according to claim 7 wherein said storage device is housed within said computer system.

10. Apparatus according to claim 7 wherein said storage device is housed externally of said computer system.

11. Apparatus comprising:
a computer readable media; and
program instructions stored on said media accessibly to a computer system and effective, when executed on said computer system, to cause the system to:
respond to powering on of the computer system by;
executing, in a computer system having an accessible read/write storage device, program instructions effective on powering on of the system to initiate system operation;
generating in response to powering on of the system a nonce string in the read/write storage device;
prompting an operator of the system to enter a password by the execution of the program instructions;
generating a hash value from the nonce string, the password and the system binding key for the read/write storage device;
supplying the hash value to the read/write storage device;
verifying in the read/write storage device that the hash value is derived from the nonce string, the password and the system binding key; and
granting read/write access to the read/write storage device on verification of the hash value.

12. Apparatus comprising:
a computer readable media; and
program instructions stored on said media accessibly to a computer system and effective, when executed on said computer system, to cause the system to:
respond to installation of a read/write storage device in a computer system by,
executing, in the computer system receiving the read/write storage device, program instructions effective on powering on of the system to initiate system operation;
identifying the presence of the read/write storage device and generating a binding key linking the read/write storage device specifically to the computer system;
prompting a designated user to enter a password for controlling access to the read/write storage device; and
generating a hash value from the binding key and password and storing the hash value in a protected area of the read/write storage device for subsequent retrieval in exercising control of system access to the read/write storage device; then causing the system to;
respond to subsequent powering on of the computer system by;
executing, in the computer system having the read/write storage device, program instructions effective on powering on of the system to initiate system operation;
generating in response to powering on of the system a nonce string in the read/write storage device;
prompting an operator of the system to enter a password by the execution of the program instructions;
generating a hash value from the nonce string, the password and the system binding key for the read/write storage device;
supplying the hash value to the read/write storage device;
verifying in the read/write storage device that the hash value is derived from the nonce string, the password and the system binding key; and
granting read/write access to the read/write storage device on verification of the hash value.
